(19) United States
(12) Patent Application Publication
(10) Pub. No.: US 2012/0017231 A1
(43) Pub. Date: Jan. 19, 2012

(54) BEHAVIOR MONITORING SYSTEM

(76) Inventor: Jackson Chao, Seattle, WA (US)

(21) Appl. No.: 13/245,536

(22) Filed: Sep. 26, 2011

Related U.S. Application Data
(63) Continuation-in-part of application No. 12/882,429, filed on Sep. 15, 2010.
(60) Provisional application No. 61/242,718, filed on Sep. 15, 2009.

(51) Int. Cl. H04H 60/33

(52) U.S. Cl. 725/12

(57) ABSTRACT

An electronic device that is configured to gather information from the environment surrounding the consumer. The information is passed along to a central computer facility that can evaluate the information to determine, for example, what television shows are being watched and the number of viewers watching the content. Additional features provide compensation methods rewarding viewers for particular content that is viewed.

### PRIORITY CLAIM

This is a continuation-in-part application of U.S. application Ser. No. 12/882,429 filed Sep. 15, 2010 which claims the benefit of U.S. Provisional Application Ser. No. 61/242,718 filed Sep. 15, 2009; contents of which are incorporated by reference.

### BACKGROUND OF THE INVENTION

There are currently many different systems that are used in an effort to monitor consumer behavior and preferences. For example, certain media companies attempt to track the particular radio or television shows watched or listened to by consumers in order to determine the size of the audience and the characteristics of the audience by age, gender, or other aspects. Many of those tracking systems are only an approximation of the actual activities of the listeners. For example, in some versions the listeners record their own behavior and may not do so accurately. In other versions an electronic box is configured together with a television or radio to more closely determine the channel to which the radio or television is tuned. Though such systems are better, they cannot determine whether the individual is actually in the same room as the television or radio or whether the device is simply on but out of earshot or beyond the field of view of the consumer.

In addition, there are many related consumer behaviors that are desirable to know but which have been elusive. For example, tracking choices of restaurants, grocery stores, gas stations, or other outlets has been difficult, if not impossible. Beyond the use of consumer surveys, there has been no ability to determine the behaviors of consumers for such establishments, and certainly none that can do so in an automated fashion.

### SUMMARY OF THE INVENTION

The preferred version of the present invention uses a portable electronic device that is configured to gather information from the environment surrounding the consumer. The information is passed along to a central computer facility that can evaluate the information to determine, for example, what television shows are being watched or what restaurant is being visited.

### BRIEF DESCRIPTION OF THE DRAWINGS

FIG. 1 is an illustrative view of a plurality of handheld devices in accordance with the invention.

FIG. 2 is a flow diagram for a preferred method of practicing the present invention.

FIG. 3 is a prior art illustration of a method for identifying audio files.

FIG. 4 is a representative illustration of a preferred method for aggregating and storing collected data for analysis.

FIG. 5 is a representative illustration of a preferred method for scanning or sampling physical media such as printed matter.

FIG. 6 is a perspective view of a further preferred system for capturing audiovisual information for behavior monitoring.

FIG. 7 is a block diagram of a system incorporating the components of FIG. 6.

### DETAILED DESCRIPTION OF THE PREFERRED EMBODIMENT

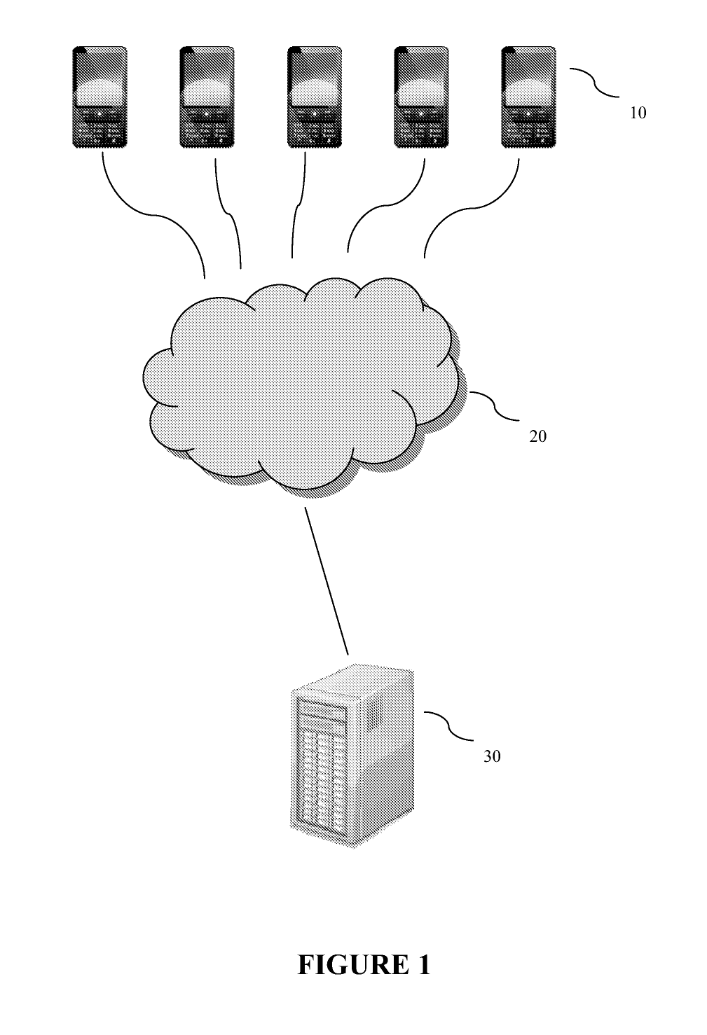

As shown in FIG. 1, any number of hand-held devices 10 may be used, in which each of them is in communication with a remote server 30 over a network 20. Thus, with reference to FIG. 1, five separate portable computing devices are shown. In practice, however, there is no limit on the number of portable computing devices that may be used. Each of the devices is preferably equipped with a means for communicating with a server for aggregating and analyzing the data forwarded to the server. The cloud in FIG. 1 represents a network 20 in which the portable computing devices communicate with the server.

In a preferred form, the portable computing devices are cellular phones, especially a cellular phone that is capable of running tailored application software. Such phones may be, for example, an Apple iPhone, a Blackberry, a Palm Treo, or other such device. Ideally, each such phone includes a microphone and a means for determining location of the phone. The location determination component within the phone may be, for example, a computer software application capable of resolving location based on the reception of GPS signals, or as another example, a computer software application for resolving location by triangulating cell tower signals.

The network shown in FIG. 1 may be any communications network for transferring data from the portable computing devices to the remote server. In one version, the network may be a cellular phone network, including a mixture of wireless cellular components and wired transmission stations and accompanying land lines. In another version, the network may include the Internet or a portion of the Internet as a means of transferring the data from the computing devices to the server. Especially dedicated communications networks may also be employed, and yet other combinations may be used in order to transfer data wirelessly from the portable computing device to a remote server.

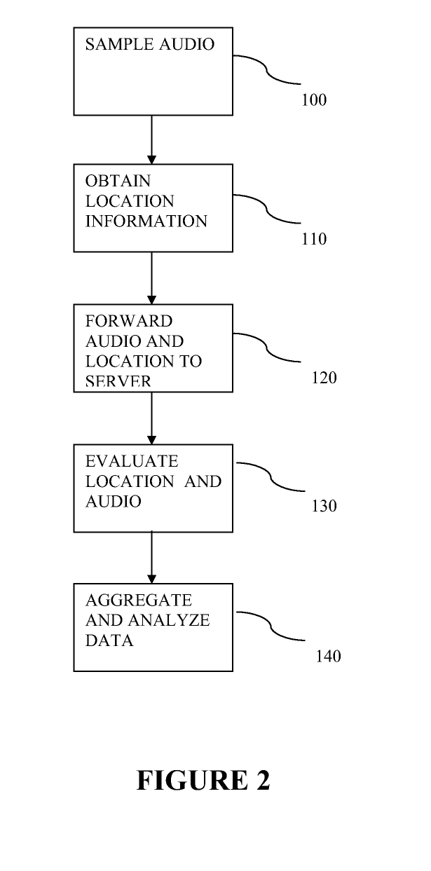

As shown in FIG. 2, in accordance with a preferred method implemented by the invention, in a first step 100 the remote computing devices sample audio information from the background in the vicinity of the remote computing device. At one extreme, the remote computing device may continuously record the audio in the vicinity of the device, and thus “sampling” the audio includes sampling continuously. Alternatively, the sampling may comprise taking discrete samples rather than continuous samples. The intervals and length of the discrete samples can be determined as a function of the preference of the implementation and the availability of bandwidth and processing abilities of the portable computing device, the network, and the server.

The sampling of the audio makes use of the microphone built into the computing devices, saving the audio sample in the memory built into the portable computing device. Thus, the portable computing device will record samples of background noise such as music (from the radio or other sources), television shows, movies, conversation, or other sources.

In some cases the most prominently detected background noise may be produced by the portable computing device. For example, the device may be playing recorded songs, a movie, a video game, or streaming audio or video. In such cases, the software used to sample the audio may elect to bypass the microphone and instead use the audio signals as they are passed to the speaker of the portable computing device in order to obtain a clearer audio signal. In addition, when transmitting the information to the server the portable computing device may transmit a flag or other indicator that the source of the audio sample was originally from the device itself. If the audio file is from the device itself but is received by the device from a broadcast source such as streaming audio or video from an Internet site, the transmission to the server will likewise include an indication of that source.

In some versions of the invention, the portable computing device may forward audio information to the server without also passing along location information. The election to provide only audio information may be because a particular computing device is not equipped with a location function, or may be because a particular consumer has elected not to enable an associated device to pass along location information with the audio information.

In the preferred version of the invention, location information is also passed along to the server from the portable computing device in a second step 110. As shown in FIG. 2 at a third step 120, the location and audio information are preferably passed along contemporaneously so that a particular audio sampling is matched with a particular location. In this way, the server can associate the audio with the location and thereby perform more meaningful analyses in a fourth step 130. In other versions of the invention, the audio and location information are passed along at separate times or at least in separate files or separate data packets. In such versions, the separate audio and location samples preferably are associated with a time so that they can be later linked together.

Thus, for example, a particular audio sample and location may be obtained contemporaneously by the portable computing device. The audio sample may be sent to the server by itself but with an indication of an associated time. The location sample may be sent at a later time, but also with an indication of an associated time that corresponds to the location. In such an implementation, a number of discrete audio samples may be taken and sent together in a delayed fashion, with times associated with each of the samples. Likewise, a number of location samples may be obtained and transmitted in the same way. As another alternative, the location and audio samples may be matched by the portable computing device and transmitted in real time (or approximately real time) or in a batch form after a period of delay.

At the server, the audio and location information are analyzed and aggregated by the server in a fifth step 140. The principal objectives in analyzing the audio portion is to identify the audio signal and, to the extent possible, to determine the source of the signal. The audio signal may be identified by comparing the audio signal against a database of audio signals for comparison. Accordingly, the server contains a reference database for comparative purposes in order to facilitate identification of the audio samples provided by each of the portable computing devices.

One method for identifying the audio samples is by comparison of acoustic fingerprints. An acoustic fingerprint is a condensed digital summary that is generated from an audio signal. There are several acoustic fingerprint techniques that may be used including, for example, those described in U.S. Pat. No. 7,277,766 and U.S. Pat. No. 5,918,223. These or other fingerprinting techniques, including those that are considered to be open source and non-proprietary, may be used. Likewise, other audio comparison techniques may be used that are not necessarily considered to fit within a currently understood definition of acoustic fingerprinting.

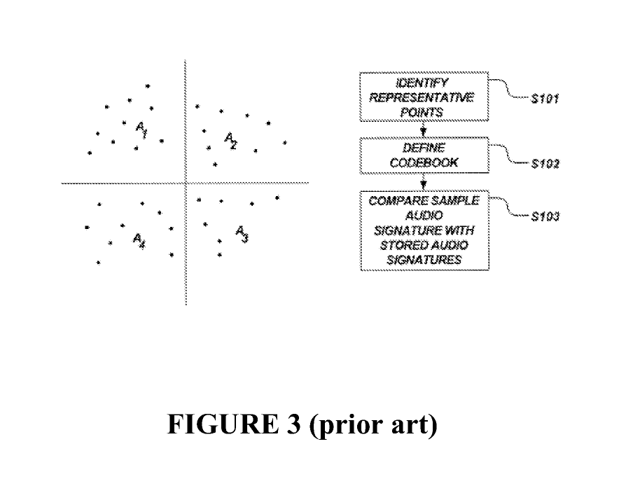

As explained in U.S. Pat. No. 7,277,766, one method for identifying audio files includes the determination of a plurality of vectors for each music sample, assigning the vector values as a signature or fingerprint for the associated audio file. FIGS. 10A and 10B of the '766 patent are reproduced in FIG. 3; the remainder of the '766 patent is incorporated by reference as an exemplary method of obtaining a digital signature and comparing such digital signature of an audio sample against a database of stored digital signatures to obtain a match.

By using techniques such as the comparison of acoustic fingerprints for sampled audio files and comparing them with a stored database for known audio files, the invention can identify a particular audio sample. The library of stored audio files may include songs and may also include audio files for movies, television shows, or other audio sources. Thus, the identification of the audio sample may include determining the name of the song from which the sample is drawn, and may also include determining a movie or television show from which the sample is drawn.

In addition to identifying the sample, the invention preferably identifies the source of the sample. Thus, the server includes a database that associates audio files with radio and television broadcasts and times of day for those broadcasts. In one example, the audio file may be identified and then the identified audio file matched against a database of radio, television, or other broadcasts to determine the source of the broadcast. In another example, the radio, television, or other broadcasts will also be assigned specific acoustic fingerprints such that the step of identifying the audio file and the source of the audio file are completed in a single step.

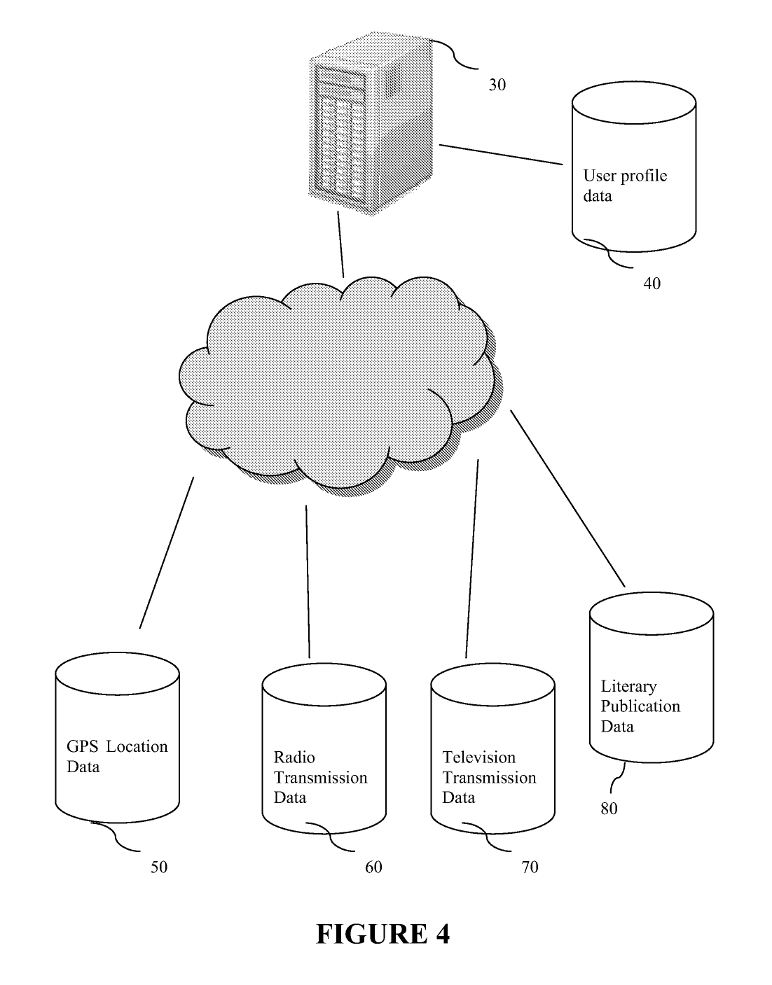

With reference to FIG. 4, the server 30 is in communication with a database (which is represented as multiple databases but may be considered to be a single database). One portion of the database (or one discrete database) includes user profile data 40 as described further below. The user profile database includes a minimal set of user demographic information such as the age, gender, and race of the user. A user identifier is provided for each user in order to match the demographic information with the audio and location sample information provided by each portable computing device. Another portion of the database includes GPS location data 50. As shown above, this database or portion of the database may be located separately across a network from the server. Alternatively, it may reside locally with the server. In either event, the location database includes data sufficient to enable a particular GPS location to be resolved to a business type or exact business name. Though this is referred to as a GPS location database and GPS is preferred, it should be understood that other methods such as cell tower triangulation are possible and the location database would be amended to accommodate such location determination methods. Additional databases include radio 60 and television transmission data 70 and library publication data 80 to provide a library of comparison in order to determine the source of an audio sample. In the event movies or other audio files are to be resolved, still further databases are provided in order to compare the audio sample against data stored in the database.

The location determination is also preferably used, either separately or to enhance the ability to determine the source of the audio sample. For example, radio broadcasts may be similar or identical, even from different radio stations. For example, a single syndicated radio show may be broadcast from many different radio stations across the country. Likewise, different television stations in different parts of the country may be broadcasting the same television shows at the same time. By accessing the location information, the server can determine that a particular audio file is more likely to be associated with a radio or television station in a particular location close to the location of the portable computing device, rather than one or more other stations at a more distant location.

In a similar fashion, the location information can be used to determine that the portable computing device is located in a theater, restaurant, or other location. The server is in communication with a database that can determine the facility at a particular location. In one version, the server is in communication with a database that includes a lookup table matching the identification of businesses with a GPS or similar location-based indication of the business. The table further includes a category for the business, such as grocery store, gas station, restaurant, and the like. Thus, by knowing the location of the computing device, the server can determine that it is currently at a theater, restaurant, grocery store, or other such business location. In the event the audio sample is drawn from a movie, the location sample data can be used by the server to determine the theater where the portable computing device is located. The server can therefore determine that the consumer watched a particular movie at a particular theater at a particular time of day.

In many instances, the audio file may be identified as simply background noise such as street noise, conversation, or the like. Especially in those cases (though not limited to those cases), the location information may provide the most useful consumer behavior information. By tracking the location of the device, the server can determine both the businesses visited by the consumer having the device and the amount of time spent in such businesses. Thus, the location information can be used to determine that the user is at a grocery store, bookstore, shopping mall, or other business, and the accompanying time data can be used to determine the amount of time spent in such establishments. The audio sampling may also be used in such instances, though the location information may be used to determine that the audio sample is background noise rather than a song, movie, or other audio source selected by the consumer.

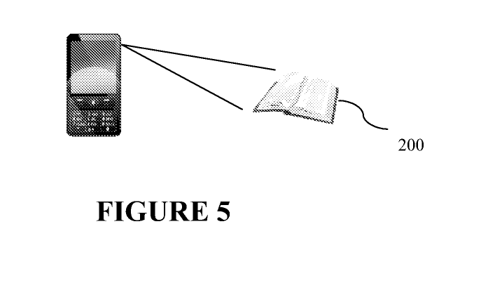

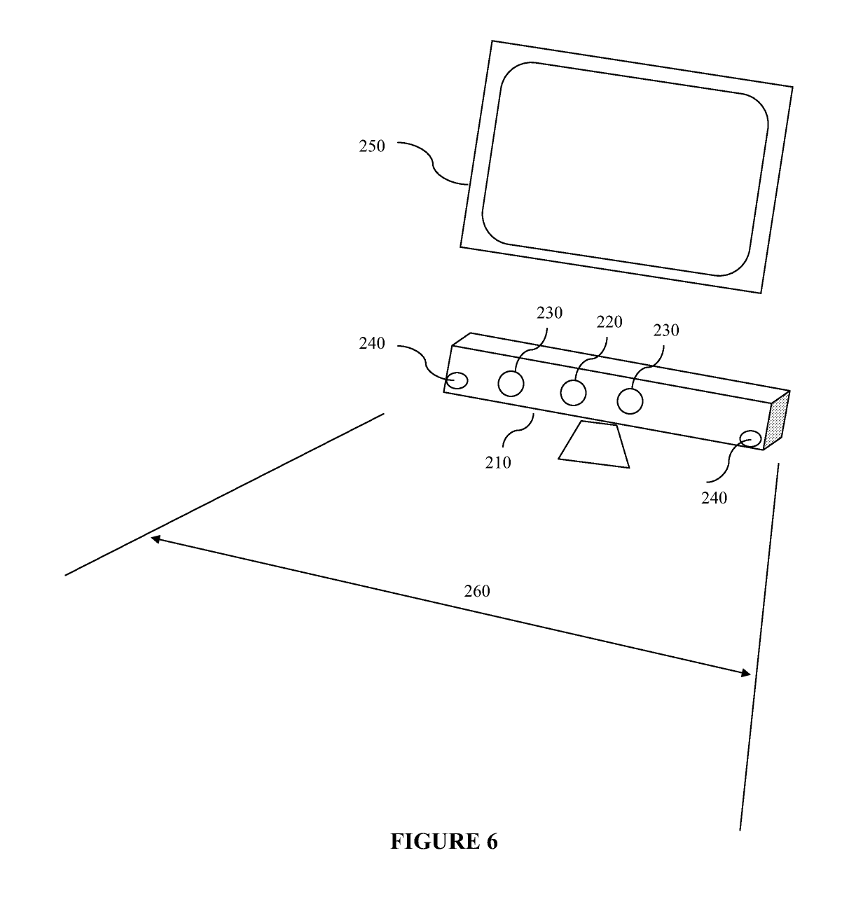

In the above description, the portable computing devices are principally sampling audio and location information for transmission and aggregation by the server. In some versions, the computing device may also (or alternatively) capture visual information in addition to audio information. Thus, for example, with reference to FIGS. 5 and 6, the portable computing device may include a camera that is configured to capture images within the field of view of the device. The sampling application on the device is configured to cause the camera to sample the surrounding images, either in continuous or discrete samples as described above with respect to the audio data analysis and aggregation. In turn, the visual sampled information is passed along to the server for analysis.

As shown in FIG. 4, the server may be in communication with a database having literary information 80 in order to perform a comparison between the sampled visual data and that contained in the database. Thus, if the device captures an image of a book 200 as shown in FIG. 5, the server is configured to determine that the image includes text from a book and then to compare the text in the sampled image from data in the literary database to determine the particular book that is in the field of view. The literary database may include data related to books, newspapers, websites, or other such literary sources.

Likewise, other visual data may be stored in one or more additional visual databases. For example, such databases may include images of cars, storefronts, or other objects that may be within the field of view of the device. Such objects can be matched against the sampled images and then aggregated to produce reports related to books, papers, or other objects that are encountered by various persons having known demographic traits.

The software application running on the portable computer device is preferably an application that is downloaded to the device upon request. In alternate versions, the application may be loaded onto the portable computing device at the time of manufacture or at the time of initiation or authentication of the device on a network. In the event of downloading the application upon request, the application may be downloaded from a website dedicated to the downloading of general applications or to the specific application for use with audio and location sampling. One exemplary version includes an applet that is downloaded to an iPhone from the Apple application store.

In one implementation, the application when installed on the personal computing device will run continuously in the background on the personal computing device. The application includes default sampling times, and may optionally allow for user-adjustable or server-adjustable sampling periods. The sampled audio and location data may be transmitted periodically to the server at preset intervals. In another version, the data is transferred to the server only during times in which the user is not operating the portable computing device as a phone or to access information over the internet, thereby ensuring high speed transmission rates for both the data transfer and the other activities of the user.

In an exemplary version, the user is paid for the installation and use of the application. As long as the application is installed and operating, the user receives a periodic payment (monthly, for example). The payment may be adjusted depending on the features the user initiates. Some users, for example, may be uncomfortable with the location information but do not mind the transmission of audio information. In that case the operation of the application is still useful but the information is somewhat less valuable. Accordingly, the user is paid a lower price than for those users who initiate the location and audio information. Likewise, the pricing may be adjusted depending on the actual use of the personal computing device. For example, the server may determine that the device is powered off much of the time or is rarely in a position to obtain audio samples, thereby determining that either no payment or a lower payment is to be made.

At the time of installation of the application onto the portable computing device, or at the time of initiation of the application, the server collects a minimal set of personal information related to the operator of the device. Preferably, the information includes the age, gender, and race of the operator. It may also include information such as the occupation, income level, residence address, marital status, or other such demographic information. In one version, the system may provide a higher payment for use of the application as a function of the amount of personal information that is provided and authorized to be used in analyzing and aggregating the data.

Ultimately, the information obtained from the portable computing devices is most useful when combined with a large number of such devices, and generally is of no use in an individual level. Thus, data from many devices is aggregated to provide reports on the behaviors of users over various periods of time.

Depending on the amount of information gathered, the server can produce reports regarding (for example) the listeners of particular radio stations over a particular period of time, including the length of time and the race, age, and gender of the listeners. The same information can be obtained for television viewers. Data for attendance at movies can also be determined in the same way.

Data for consumer behavior that is less dependent on audio sampling can also be aggregated. Thus, by identifying grocery stores, gas stations, bookstores, and other businesses, the server can aggregate the collected data to produce summary reports regarding the age, gender or other demographic characteristics of consumers visiting those establishments. It can also determine average lengths of time spent at such businesses. The resulting summary reports therefore provide reliable information on consumer behavior drawn from actual recorded sounds and actual locations that are automatically sampled, rather than from self-reported information produced in consumer surveys. The information is therefore more reliable and more detailed than current consumer tracking methods.

FIG. 6 illustrates a further preferred system for capturing audiovisual information for behavior monitoring. In the system as illustrated in FIG. 6, the computing device is illustrated as one that is more preferably fixed in position rather than a portable device as described above. Other than the distinction between being fixed or portable, however, many of the features are similar. One difference, however, is that the system as illustrated in FIG. 6 more readily incorporates one or more sensors to determine the presence of one or more persons in proximity with the sensing device.

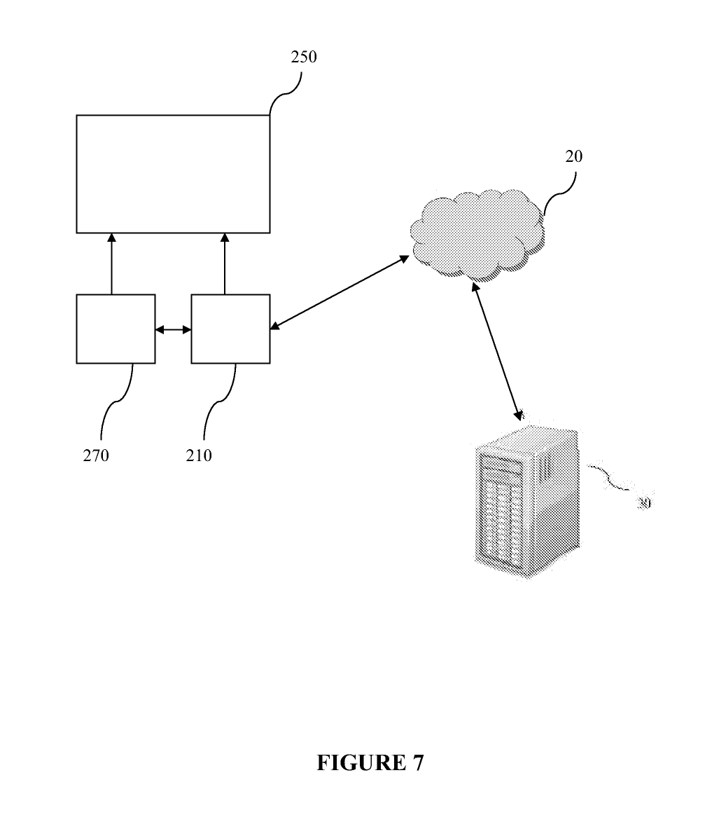

As illustrated, an exemplary system includes a computing device 210 placed in an area to be monitored, such as in a living room or other area within a home. Ideally, the computing device may take the form of a Kinect® sensor bar available for use with an Xbox® video game system. Such a device is desirable for use with the present system because it is readily available and may be commonly already installed in a home. Although illustrated in FIG. 6 as showing only the sensor bar portion of the computing device, it should be understood that the system would preferably incorporate the console as well. This aspect is more readily shown in the block diagram of FIG. 7, as discussed below.

The computing device 210 includes one or more sensors, preferably including a camera 220, one or more depth sensors 230, and one or more microphones 240. Ideally it includes a processor and a memory containing programming instructions for carrying out the process of the invention as described in this specification. Such a processor and memory may be incorporated into what is illustrated as a currently available sensor bar sold under the Kinect® brand, or may alternatively be incorporated into a separate console such as the Xbox® console (not illustrated in FIG. 6) which would typically be communicatively coupled to the sensor bar in a wired or wireless fashion.

The computing device 210 is typically mounted adjacent a television or monitor 250, and in most cases is best positioned just above or just below the television. The sensors 220, 230, 240 generally define a field of view 260 that encompasses an area in the vicinity of the computing device that can be monitored. Consistent with the current invention, it is possible to use multiple sensor bars, different sensors, or different placements of the computing device and sensor other than as illustrated in FIG. 6.

FIG. 7 provides a block diagram of a preferred system such as that described in FIG. 6. The system preferably includes a multimedia device 250 such as a television having audio speakers. The television receives its input either directly from a cable signal or through either one of a set top box 270 or the computing device 210 (which may be a video game console and incorporated sensor bar). The set top box may be, for example, a satellite or cable television receiver. In some versions, the set top box and computing device may be connected to one another. Likewise, in some cases the set top box may be excluded. In yet another version, the computing device may be in the form of an additional computing device connected to the console and/or the television to gather information related to the field of view and the content played on the multimedia device.

The computing device is, directly or indirectly, connected to a network 20 such as the Internet, and then to a remote server 30 such as described above.

In use, the system is configured to capture behavioral information and link it to multimedia information. More particularly, the sensors associated with the computing device 210 capture information indicating the presence of one or more persons within the field of view. Thus, the computing device contains programming allowing it to capture the image and depth information from the sensors to determine the number of individuals that are in place within the field of view.

The field of view information is matched with the multimedia information such as television content being watched to determine the number of persons watching the particular television content at a particular time. In one version, the computing device 210 may include programming allowing it to match television content with viewers, and then stores that information locally before sending it along over the network 20 to a remote server 30 or other such remote computer. In an alternate version, the computing device passes along viewer information and television content information separately to the remote server, which receives and processes the information. In yet another version, the computing device receives and sends viewer information only, and the remote computer receives television content information separately from the set top box 270 or another source. In this version, the remote computer 30 subsequently links the viewer and content information based on time data or other aspects of the data passed along that allows the information to be matched.

At the remote server (or yet another location where the data may be sent for processing) the server processes the information to determine the number of viewers within the field of view for particular programming content. Because the viewer and media content information are both captured continuously and in real time, the server can further determine whether viewers remained in the field of view for any portion of the program. Thus, it can determine the percentage of time that viewers remained in the field of view, and can further determine whether viewers left the field of view during commercials or other specific portions of programming content.

Using the current system, television content monitoring systems can obtain much more specific and reliable information than current data that may be self-reported. It is also much more accurate than television tuning data because such monitoring systems can only determine that a television is tuned to a particular channel but cannot definitively determine whether anyone is actually in the vicinity watching the content. Still further, viewers may readily leave the room during commercials, and the data is often of primary value to advertisers wishing to know how many people watched the commercial. Information from present systems is only an approximation of commercial viewership because there is no way to determine whether the viewers left the room. The invention as described above overcomes these disadvantages by providing accurate, timely, and detailed information.

In addition to being able to track the viewership information more closely, the present system allows for a method of encouraging commercial viewing and compensation for such viewing. In such a system, viewers are provided a payment for each commercial they watch. The payment may be constant or may be a function of particular times of day in which commercials at certain times are paid at a greater rate than at other times. At the server (or optionally at the computing device 210) the system determines the number of viewers in the field of view during commercial portions of television content. The system then calculates payment for commercial viewing over a period of time (for example, monthly) by multiplying the commercials watched by the rates applicable to such commercials. In this manner, viewers can be compensated for watching commercials rather than for watching television content and skipping the commercials.

In further variations of the present invention, the system can provide incentives for viewers to invite others to watch specific content and to receive compensation for the increased viewership. In such a system, the compensation paid to the viewer may be a function of the number of viewers times the number of commercials watched by those viewers, multiplied by the applicable rates.

In some versions of the invention, the system can solicit and receive feedback from the viewers in an audible or visual form. In the example described above, the system can detect the presence of viewers within the field of view 260 of a computing device 210. The computing device is further programmed to detect particular movements or gestures of individuals within the field of view and to resolve those movements into recognizable patterns.

In one example of the feedback implementation, programming on the display 250 may solicit feedback from viewers in the form of a raised hand. Thus, the programming may ask for viewers to raise their hands if they are in favor of a particular proposition. As an alternative to a raised hand, the programming may ask viewers to move their bodies in another particular way, such as jumping up and down or raising both arms. In the manner as described above, one or more of the sensors 230 such as a camera and motion sensor will detect the movement and determine whether it corresponds to the requested motion.

Most preferably the system includes an ability to capture the body movement within a particular window of time following the request for a viewer movement by the programming. Accordingly, the programming is preferably accompanied by an indicator signal communicated to the set top box 270 or the local computer 210 to initiate a beginning period in which movements by viewers are evaluated for a corresponding feedback movement or gesture such as a raised hand. The local computer or set top box may have an automatically timed ending period or, alternatively, the lack of a positive confirmation of a corresponding feedback movement may be interpreted as a negative result (that is, the viewer did not move in the requested manner).

Instead of (or in addition to) the physical movement, the viewers may be asked to make an audible response such as saying “yes” or “no” or providing some other requested verbal response to a programming question or statement. In such an instance, the computer 210 through a sensor such as a microphone 240 will listen for audible responses and analyze them using speech recognition or the like to determine whether there is a response matching the request. As with the physical gestures, an accompanying initiating indicator signal is preferably used to create a beginning time for evaluation of the viewer audible responses.

The response information received by the local computer 210 is ultimately sent to the server 30 over a network 20 such as the Internet. Most preferably, each local computer sends a signal indicating the number of viewers within a field of view at the time a polling question or statement was sent or included in the programming, as well as the number of such viewers that indicated a positive response (or, alternatively, a negative response) to the question or statement posed. Additional response data may be transmitted, as appropriate to the question or statement posed.

At the server, the server is programmed to aggregate the responses from the plurality of similarly programmed and configured local computers in order to analyze the response data. In this manner, the server is able to calculate a percentage of viewers in favor of or opposed to a particular proposition, for example.

In addition to aggregation, the server may evaluate individual viewer responses and take a further corresponding action, such as sending a product, service, or information to the viewer. For example, the server may send a coupon or an informational brochure to the home of each viewer that raised a hand in response to an inquiry asking whether viewers would like to be sent a coupon or brochure.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system, comprising:
a multimedia player viewable from within a field of view, the multimedia device being configured to play multimedia content;
a computing device having a sensor for capturing images of one or more viewers within the field of view, the computing device containing stored programming instructions to (1) determine the number of viewers within the field of view and (2) link the number of viewers within the field of view to the multimedia content;
whereby the system determines the number of viewers within the field of view during the playing of the multimedia content.

2. The system of claim 1, wherein the computing device determines the number of viewers within the field of view continuously over a period of time.

3. The system of claim 1, wherein the multimedia content comprises television programming and at least one commercial, and further wherein the stored programming instructions determine the number of viewers within the field of view separately during playing of the television programming and during playing the at least one commercial.

4. The system of claim 3, wherein the computing device comprises a local computing device and a remote server in communication with the local computing device over a wide area network, and further wherein the remote server is configured to link the number of viewers within the field of view to the multimedia content.

5. The system of claim 1, wherein the sensor further comprises a camera and a depth sensor.

6. A method for rewarding multimedia viewing, comprising:
placing a computing device within a field of view of a multimedia device, the computing device having a sensor for capturing images of one or more viewers within the field of view;
determining, via the computing device, the number of viewers within the field of view; and
associating the number of viewers within the field of view with the multimedia content that is played while the viewers are within the field of view.

7. The method of claim 6, further comprising rewarding at least one of the viewers for being within the field of view during the playing of the multimedia content.

8. A system, comprising:
a multimedia player viewable from within a field of view, the multimedia device being configured to play multimedia content;
a computing device having a sensor for capturing images of one or more viewers within the field of view, the computing device containing stored programming instructions to evaluate viewer feedback in response to multimedia content and to send a signal indicative of the viewer feedback;
a server in communication with the computing device, the server being programmed to receive the viewer feedback signal from the computing device.

9. The system of claim 8, wherein the viewer feedback comprises a physical movement by the viewer, and further wherein the computing device contains a motion sensor to detect the physical movement by the viewer and stored programming instructions to determine whether the physical movement by the viewer corresponds to a requested physical movement.

10. The system of claim 9, wherein the motion sensor further comprises a camera and a depth sensor.

11. The system of claim 9, wherein the requested physical movement comprises raising a hand.

12. The system of claim 8, wherein the viewer feedback comprises an audible response by the viewer, and further wherein the computing device contains a microphone to detect the audible response by the viewer and stored programming instructions to determine whether the audible response by the viewer corresponds to a requested audible response.

13. The system of claim 8, wherein the server is programmed to aggregate a plurality of viewer feedback signals and determine a percentage of viewer feedback signals that correspond to a requested viewer feedback response.
